(19) United States
(12) Patent Application Publication
(10) Pub. No.: US 2007/0101286 A1
(43) Pub. Date: May 3, 2007

(54) Icon displaying apparatus and icon displaying method

(75) Inventors: Takeshi Minami, Nagano-Ken (JP); Eiji Tanaka, Nagano-Ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/544,904

(22) Filed: Oct. 5, 2006

(30) Foreign Application Priority Data
Oct. 5, 2005 (JP) JP 2005-292734
Oct. 26, 2005 (JP) JP 2005-311835
Nov. 8, 2005 (JP) JP 2005-323463

(51) Int. Cl. G06F 17/00

(52) U.S. Cl. 715/779; 715/517; 715/765

(57) ABSTRACT

An icon display apparatus includes: a launcher width acquiring section that acquires a launcher width in the icon arranging direction in the launcher region in which a plurality of icons are arranged to display; the number of icons calculating section that calculates the number of icons arranged in the launcher to display at a time based on the launcher width acquired by the launcher width acquiring section and the icon width for each of the plurality of icons; an integrated width calculating section that calculates an integrated width in the icon arranging direction in which the number of icons calculated by the number of icons calculating section are arranged; and an arrangement section that arranges the line of icons at the center of launcher based on the integrated width and the launcher width.

### CROSS REFERENCE TO RELATED APPLICATION

The present application claims priority from Japanese Patent Applications No. 2005-292734 filed on Oct. 5, 2005, No. 2005-311835 filed on Oct. 28, 2005 and No. 2005-323463 filed on Nov. 8, 2005, the contents of which are incorporated herein by reference.

### BACKGROUND

1. Field of the Invention

The present invention relates to an icon displaying apparatus, an icon displaying method and a program therefor. Particularly, the present invention relates to an icon displaying apparatus, an icon displaying method for arranging a plurality of icons to display the same and a program therefor.

2. Related Art

A displaying apparatus for displaying a plurality of icons in a launcher provided in an window of an application software has been known, as described in, for example, a figure of the display screen in p 140 of “Visual Guide to Microsoft PowerPoint 2000” by Nikkei BP Soft Press, published on Aug. 2, 1999. In the displaying apparatus, when the number of icons to be displayed is more than that of icons which can be displayed in the launcher, an arrow button is displayed in the launcher. When the arrow button is pushed down by a user, any icon which has not been displayed in the launcher is displayed.

However, the size of launcher is determined dependent on the size of window in the displaying apparatus. Additionally, the icons which can be displayed in the launcher at a time are arranged from the left edge. Therefore, even if the launcher is enlarged by enlarging the window by the user but the launcher is not enlarged enough to display another icon, a distance between the icon of the right edge and the right edge of the launcher is widened. Thus, the user can not find an icon which should be displayed next to the right edge icon because the distance between the right edge icon and the right edge of the launcher. That is to say, it could have been that the user think that all of the icons are displayed in the current launcher.

### SUMMARY

To solve the above-described problem, an aspect of the present invention provides an icon displaying method. The icon displaying method includes: acquiring a launcher width in the icon arranging direction in the launcher region in which a plurality of icons are arranged to display; calculating the number of icons arranged in the launcher to display at a time based on the launcher width acquired in the launcher width acquiring step and the icon width for each of the plurality of icons; calculating a integrated width in the icon arranging direction in which the number of icons calculated in the number of icons calculating step are arranged; and arranging the plurality of icons in the launcher such that the distance between one end of the launcher region and the icon arranged most close to the one end is approximately equal to the distance between the other end of launcher region and the icon arranged most close to the other end.

Thereby the user does not misunderstand that all of the icons are displayed.

Here, all necessary features of the present invention are not listed in the summary of the invention. The subcombinations of the features may become the invention.

### BRIEF DESCRIPTION OF THE DRAWINGS

FIG. 1 shows an example of icon displaying apparatus 10;

FIG. 2 is a block diagram of a main body 12;

FIG. 3 is a schematic diagram of an example of display on a display screen 50;

FIG. 4 is a block diagram of the main body 12;

FIG. 5 is a schematic diagram of an example of display on the display screen 50;

FIG. 6 shows an example of icon 210 in a launcher region 70;

FIG. 7 is a flowchart showing an example of operation of the icon displaying apparatus 10;

FIG. 8 shows an example of icon 210 in the launcher region 70;

FIG. 9 is a flowchart showing an example of operation of the icon displaying apparatus 10;

FIG. 10 shows an example of icon 210 and so forth in a launcher region 70;

FIG. 11 shows an example of icon 210 and so for in a launcher region 70;

FIG. 12 is a flowchart showing an example of operation of the icon displaying apparatus 10;

FIG. 13 shows an example of icon 210 and so forth in a launcher region 70

### DESCRIPTION OF EXEMPLARY EMBODIMENTS

Hereinafter, the present invention will now be described trough referred embodiments. The embodiments do not limit the invention according to claims and all combinations of the features described in the embodiments are not necessarily essential to means for solving the problems of the invention.

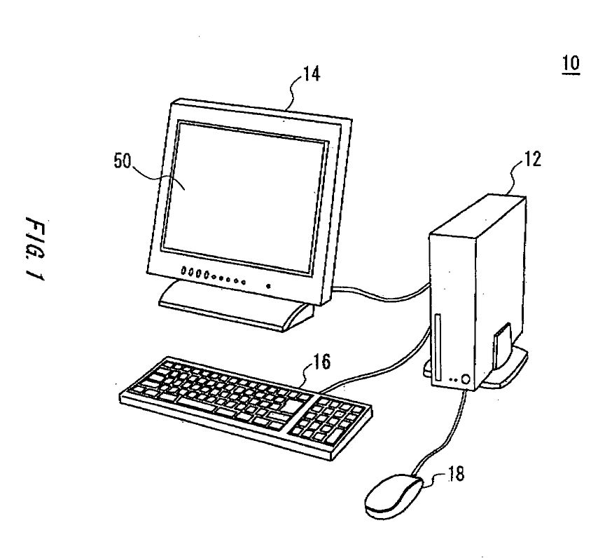

FIG. 1 shows an example of icon displaying apparatus 10. The icon displaying apparatus 10 includes: a main body 12 for executing a program which controls the icon displaying apparatus 10, a display 14 having a display screen 50, for displaying to a user based on an output from the main body 12, a key board 16 and a mouse 18 which are examples of means for inputting from the user to the main body 12.

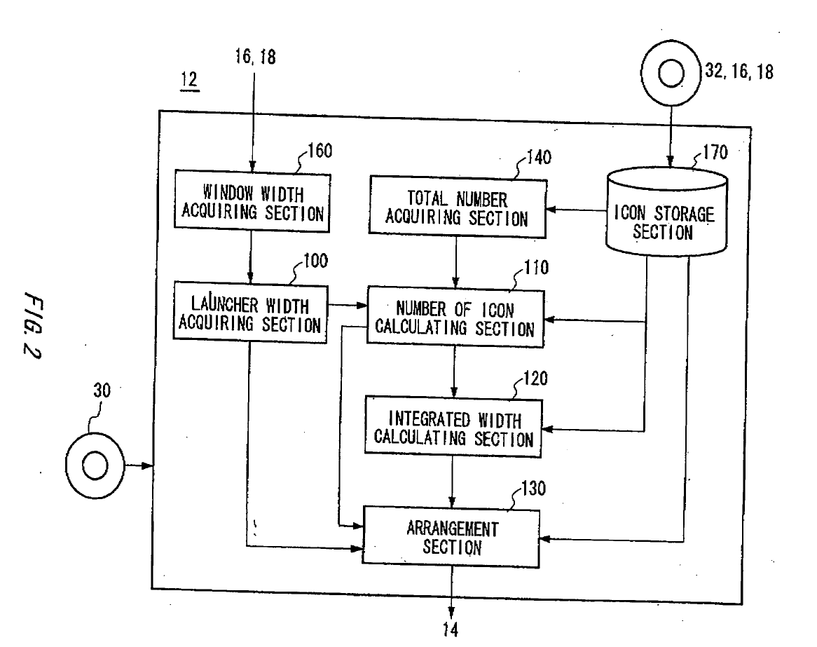

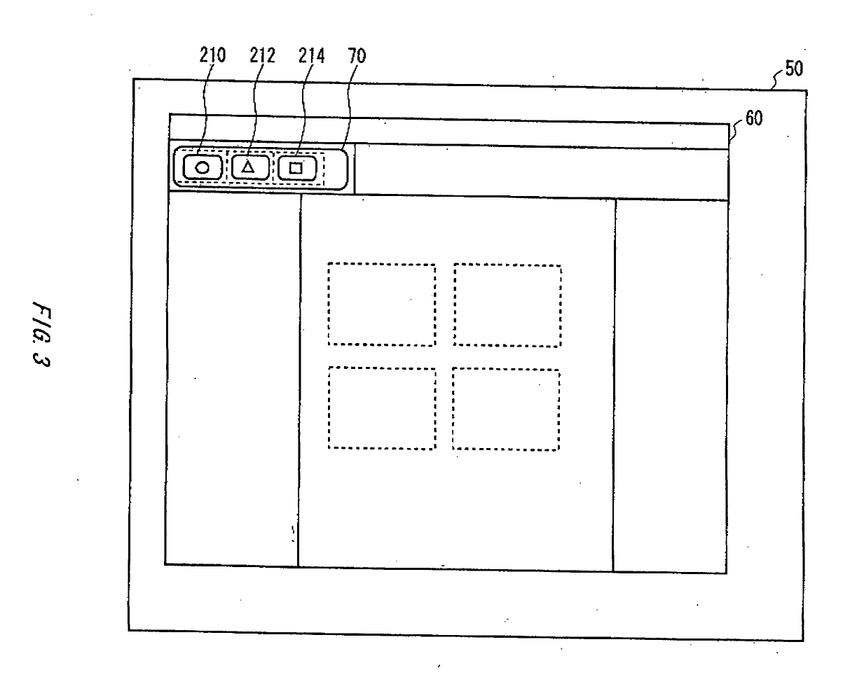

FIG. 2 is a block diagram of the main body 12. FIG. 3 is a schematic diagram of an example of display on the display screen 50 by he main body 12. As shown in FIG. 2, the main body 12 includes a launcher width acquiring section 100, the number of icons calculating section 110, an integrated width calculating section 120, an arrangement section 130, a total number acquiring section 140, an window width acquiring section 160 and an icon storage section 170.

The window width acquiring section 160 receives from an user an instruction that an width of the window 60 shown in FIG. 3 will be changed through an input means such as the mouse 18. The window width acquiring section 160 determines a launcher width being an width in the lateral direction of the launcher region 70 in which a plurality of icons are arranged laterally to display based on the width of the window 60 and notifies the launcher width acquiring section 100 of the determined launcher width.

The launcher acquiring section 100 acquires a launcher width from the window width acquiring section 160. The launcher width acquiring section 100 provides the acquired launcher width to the number of icons calculating section 110 and the arrangement section 130.

The icon storage section 170 stores information on the icons to be displayed on the launcher region 70. Specifically, the icon storage section 170 stores the image of an icon and an icon width which is an width in the lateral direction of the icon image. The icon storage section 170 fiber stores information on the arrangement order of icon images displayed in the launcher region 70 in the lateral direction (hereinafter referred to as “arrangement order information” The arrangement order information is determined as follows, for example. The icon storage section 170 acquires icon images through a storage medium 32. The icon storage section 170 determines the arrangement order information dependent on the order by which the icon images are acquired. The icon storage section 170 may acquire the icon images through a communication line as substitute for the storage medium 32. Additionally, the icon storage section 170 receives the change of the arrangement order information through the keyboard 16 or the mouse 18.

The total number acquiring section 140 acquires the total number of icons by referring the number of icons IDs stored in the icon storage section 170. The total number acquiring section 140 provides the calculated total number of icons to the number of icons calculating section 110.

The number of icons calculating section 110 calculates the number of icons to be arranged laterally in the launcher region 50 to display at a time based on the launcher width acquired from the launcher width acquiring section 100, the arrangement order information stored in the icon storage section 170 and the icon width. In addition, the number of icons calculating section 110 acquires icon IDs to identify the icons to be arranged in the launcher region to display at a time. Further, the number of icons calculate section 161 determines whether the total number of icons acquired by the total number acquiring section 140 can be arranged laterally in the launcher region 70 to display at a time based on the launcher width acquired by the launcher width acquiring section 100 and the icon width stored in the icon storage section 170.

The number of icons calculating section 110 notifies the integrated width calculating section 120 of the number of icons to be displayed in the launcher 70 at a time and the determination whether the total number of icons can be displayed at a time. In addition to the number of icons, the number of icons calculating section also notifies of the acquired icon ID the integrated width calculating section.

The integrated width calculating section 120 calculates an integrated width in which the number of icons calculated by the number of icons calculating section 110 are laterally arranged based on the number of icons acquired from the number of icons calculating section 110, the arrangement order information stored in the icon storage section 170 and the icon width. Specifically, the integrated width calculating section 120 calculates the integrated width for the icon 210, 212 and 214 in an example shown in FIG. 3. The integrated width calculating section 120 provides the calculated integrated width to the arrangement section 130.

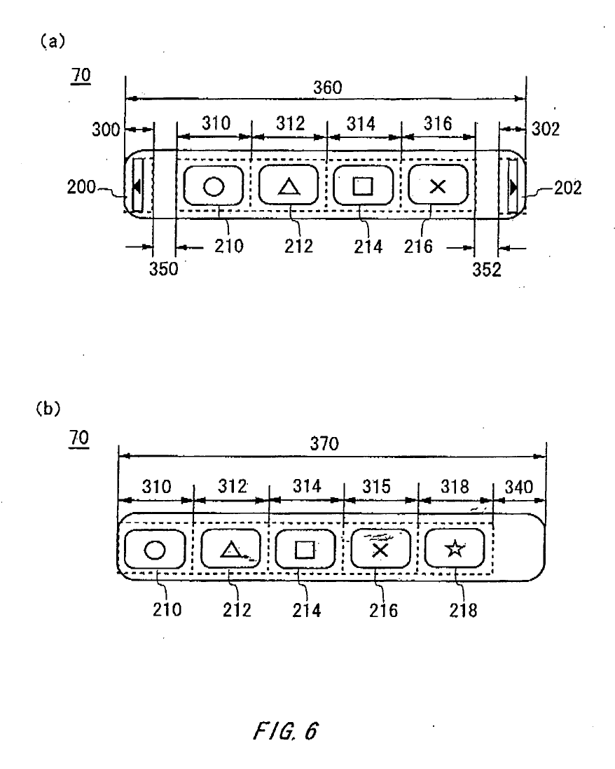

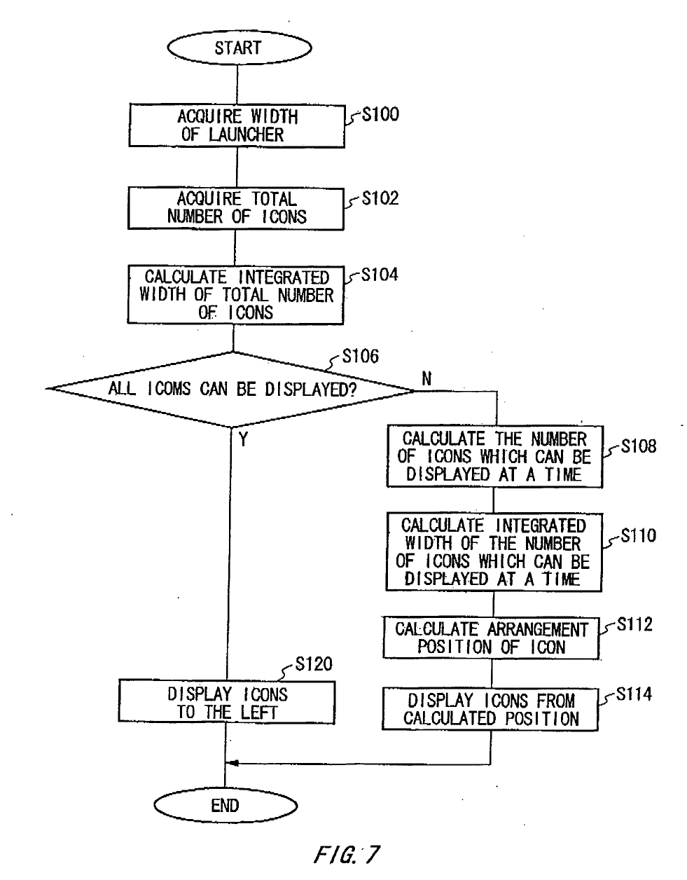

The arrangement section 130 changes the position of the line of icons in the launcher region 70 and displays the same based on whether the total number of icons can be arranged laterally in the launcher region 70 to display at a time. Such operation of the arrangement 130 will be described later with reference to FIG. 6 and FIG. 7.

The storage medium 30 stores a program which causes the launcher width acquiring section 100, the number of icons calculating section 110, the integrated width calculating section 120, the arrangement section 130 and the total number acquiring section 140 to operate. The program stored in the storage medium may be installed in the main body 12 to cause the launcher width acquiring section 100 and so forth to operate. Additionally, the main body 12 may acquire such program through a communication line.

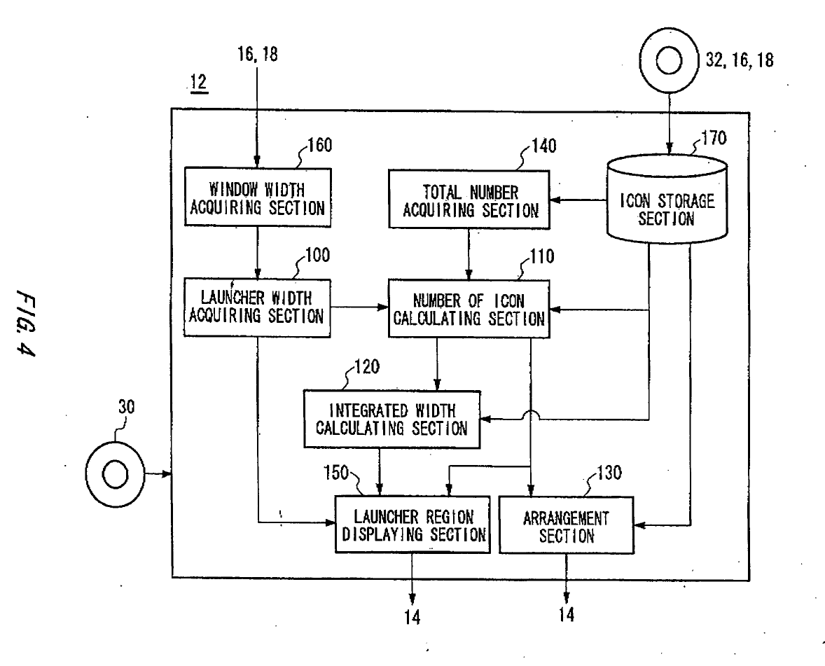

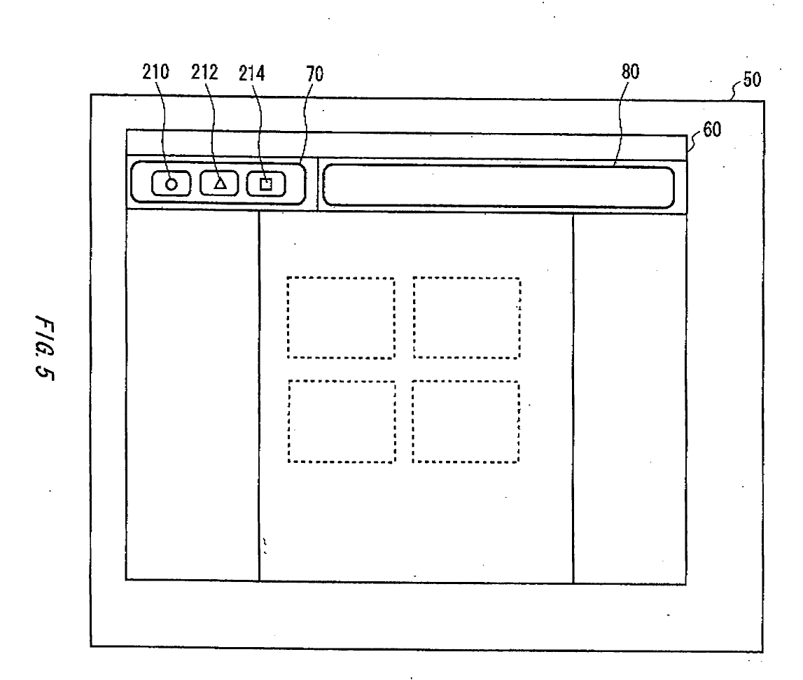

FIG. 4 shows a block diagram of the main body 12. FIG. 5 is a schematic diagram showing an example of display on the display screen 50 by the main body 12. As shown in FIG. 4, the main body 12 includes a launcher width acquiring section 100, the number of icons calculating section 110, an integrated width calculating section 120, an arrangement section 130, a total number acquiring section 140, a launcher region displaying section 150, an window width acquiring section 160 and an icon storage section 170.

The window width acquiring section 160 receives an instruction that the width of an window 60 shown in FIG. 5 will be changed from a user through an input means such as the mouse 18. The window width acquiring section 160 notifies the launcher width acquiring section 100 of the received width of the window 60.

The launcher width acquiring section 100 acquires the width of the window 60 from the window width acquiring section 160. Based on the acquired width of window 60, the launcher width acquiring section 100 calculates the maximum launcher width in the lateral direction in the launcher region 70 in which a plurality of icons are arranged laterally to display in the window 60 and provides the calculated maximum launcher width to the number of icons calculating section 10 and the launcher region displaying section 150.

The icon storage section 170 stores information on the icons displayed on the launcher region 70. Specifically, the icon storage section 170 stores an icon image and an icon width of the icon image in the lateral direction in association with an icon ID to identify each icon. Additionally, the icon storage section 170 stores images of arrow icons displayed in the launcher region 70 and an arrow width being the width of the image of the arrow icon in the lateral direction. Further, the icon storage section 170 stores a distance width being an width for the distance between icons or arrow icons when the icons or the arrow icons are arranged at a distance in the arranging direction.

Additionally, the icon storage section 170 stores the arrangement order information which is information on the order in the lateral direction of icon images displayed in tile launcher region 70. The arrangement order information is determined as follows, for example. The icon storage section 170 acquires icon images trough a storage medium 32. The icon storage section 170 determines the arrangement order information based on the order by which the icon image is acquired. The icon storage section 170 may acquire the icon image through a communication line as substitute for the storage medium 32. Additionally, the icon storage section 170 receives the change of the arrangement order information through the keyboard 16 or the mouse 18. In the same way, the icon storage section 170 receives the change of the width for the distance between icons or arrow icons.

The total number acquiring section 140 acquires the total number of icons by referring the number of icons IDs stored in the icon storage section 170. The total number acquiring section 140 calculates the integrated width of the total number of icons. Here, the total number acquiring section 140 may calculate au width obtained by adding the integrated width obtained by multiplying the icon width for each of the total number of icons and widths for distances between the total number of icons as the integrated width of the total number of icons. The total number acquiring section 140 provides the acquired total number of icons and the calculated integrated width of the total number of icons to the number of icons calculating section 110. Here, when the total number of icons are displayed in the launcher region, the integrated width may be used for the required launcher width.

The number of icons calculating section 110 determines whether the total number of icons can be arranged laterally in the launcher region 70 in which the total number of icons are displayed with the minimum launcher width to display at a time based on the maximum launcher width acquired from the launcher width acquiring section 100 and the integrated width for the total number of icons acquired from the total number acquiring section 140.

Additionally, the number of icons calculating section 110 calculates the number of icons which can be displayed at a time in the launcher region 70 displayed with the maximum launcher width based on such as the maximum launcher width acquired from the launcher width acquiring section 100, the arrangement order information stored in the icon storage section 170 and the icon width. Here, the number of icons calculating section 110 may calculate the number of icons which can be displayed at a time by comparing an width obtained by adding the icon width, the arrow width and the width for the distance with the maximum launcher width.

The number of icons calculating section 110 notifies the arrangement section 130 and the launcher region displaying section 150 of the determination whether the total number of icons can be arranged laterally at a time in the launcher region 70 in which the total number of icons are displayed with the maximum launcher width. In addition to the determination, the number of icons calculating section 110 notifies the integrated width calculating section 120 and the arrangement section 130 of the number of icons which can be displayed at a time in the launcher region 70 displayed with the calculated maximum launcher width. In addition to those, the number of icons calculating section 110 also notifies the arrangement section 130 of the total number of icons acquired from the total number acquiring section 140.

The integrated width calculating section 120 calculates an integrated width in the lateral direction in which the number of icons which can be displayed at a time are laterally arranged based on the number of icons which can be displayed at a time in the launcher region in which the icons can be displayed with the maximum launcher width acquired from the number of icons calculating section 110, the arrangement order information stored in the icon storage section 170 and the icon width. Specifically, the integrated width calculating section 120 calculates the integrated width of the icons 210, 212 and 214 in the example shown in FIG. 5. Additionally, in the example in FIG. 5, the integrated width calculating section 120 may calculate the arrow icon width (not shown in the figure) and the width for the distance between the arrow icons as the integrated width. The integrated width calculating section 120 provides the calculated integrated width to the launcher region displaying section 150.

The arrangement section 130 arranges the icon images and the arrow icon images stored in the icon storage section 170 based on the determination whether the total number of icons acquired from the number of icons calculating section 110 can be arranged laterally at a time in the launcher region 70 displayed with the maximum launcher width. Specifically, the arrangement section 130 arranges the number of icons which can be displayed at a time in the launcher region 70 displayed with the maximum launcher width from one end of the launcher region 70 while the arrow icon is arranged adjacent to at least at the other end of the line of icons in the launcher region 70 in the arranging direction, arranges the total number of icons from one end of the line of icons in the launcher region 70. Here, when the arrow icon is arranged, the arrangement section 130 may arrange the arrow icons at both ends of the line of icons.

The launcher region displaying section 150 displays the end of the launcher region 70 adjacent to the arrow icon based on the determination whether the total number of icons acquired from the integrated width calculating section 120 can be arranged laterally at a time in the launcher region 70 with the maximum launcher width.

The storage medium 30 stores a program which causes the launcher width acquiring section 100, the number of icons calculating section 110, the integrated width calculating section 120, the arrangement section 130, the total number acquiring section 140 and the launcher region displaying region 150 to operate. The program stored in the storage medium may be installed in the main body 12 to cause the launcher width acquiring section 100 and so forth to operate. Additionally, the main body 12 may acquire such program through a communication line.

Here, the window 60 has another region 80 in addition to the launcher region 70.

FIG. 6 shows an example of icons displayed in the launcher region 70. FIG. 7 is a flowchart showing an example of operation of the icon displaying apparatus 10. The flowchart starts by receiving an instruction from a user that the width of the window 60 shown in FIG. 3 will be changed. Here, at the starting point of the flowchart, the icon storage section 170 stores icons 210, 212, 214, 216 and 218. The width for each of the icons 210, 212, 214, 216 and 213 is icon width 310, 312, 314, 316 and 318, respectively. The order to arrange the icons 210, 212, 214, 216 and 218 is as the described order.

The launcher width acquiring section 100 acquires a launcher width 360 shown in FIG. 6A from the window width acquiring section 160 (S100). The launcher width acquiring section 100 provides the acquired launcher width 360 to the number of icons calculating section 110 and the arrangement section 130.

The total number acquiring section 140 acquires the total number of icons “5” stored in the icon storage section 170 (S102). The total number acquiring section 140 calculates an integrated width for the total number “5” of icons stored in the icon storage section 170, that is, the integrated width of the icon widths 310, 312, 314, 316 and 318 (S104). The total number acquiring section 140 provides the integrated width for the calculated total number “5” of icons to the number of icons calculating section 110.

The number of icons calculating section 110 determines whether the five icons can be displayed in the launcher region 70 by comparing a launcher width 360 with the calculated integrated width (S106).

Determining that the five icons can not be displayed in the launcher region 70 (S106: No), the umber of icons calculating section 110 calculates the number of icons which can be displayed at a time (S108). In an example shown in FIG. 6A, the number of icons calculating section 110 calculates the number of icons “4” which can be displayed at a time. The number of icons calculating section 110 provides the calculated number of icons to the integrated width calculating section 120.

The integrated width calculating section 120 calculates an integrated width in which the number of icons “4” which can be displayed at a time are arranged laterally, that is, the integrated width of the icon widths 310, 312, 314 and 316 based on the number of icons acquired from the number of icons calculating section 110, the arrangement order information stored in the icon storage section 170 and the icon width (S110).

The arrangement section 130 calculates an width 350 which is obtained by subtracting the integrated width of the icon widths 310, 312, 314 and 316, an arrow width. 300 of a left arrow icon 200 and an arrow width 302 of a right arrow icon 202 from a launcher width 360 and dividing the subtracted width in half. The arrangement section 130 calculates a position which is obtained by adding the arrow width 300 of the left arrow icon 200 and the calculated width 350 to the left edge of the launcher region 70 as a position of the icon 210 which is arranged at the left edge of the line of icons (S112).

As shown in FIG. 6A, the arrangement section 130 arranges the icon image of the icon 210 in the launcher region 70 such that the left edge of the icon image of the first icon 210 is the calculated position (S114). Then, the arrangement section 130 sequentially arranges the icon image of the icon 212, the icon image of the icon 214 and the icon image of the icon 216 (S114). Thereby the arrangement section 130 arranges the line of icons 210, 212, 214 and 216 at the center of the launcher region 70. Therefore, even if there is a distance between one end of the launcher region 70 and the line of icons, user's misunderstanding that all of the icons are displayed in the launcher can not be caused.

Meanwhile, the number of icons calculating section 110 determines that the total number of icons “5” can be displayed in the launcher region 70 (S106: Yes), the arrangement section 130 arranges the icon image of the first icon 210 in the launcher region 70 such that the left edge of the icon image of the icon 210 is at the left edge of the launcher region 70 as shown in FIG. 6B (S120). Then, the arrangement section 130 sequentially arranges the total number “5” of icons, that is, the icon image of the icon 212, the icon image of the icon 214, the icon image of the icon 216 and the icon image of the icon 218 (S120). For example, when the number of icons calculating section 110 acquires a launcher width 370 wider than the launcher width 360 from the launcher width acquiring section 100 because the window is enlarged by the user, the arrangement section 130 arranges the total number of icons in the launcher region 70 from the left edge. Here, the arrangement section 130 does not any arrow icon when the line of the total number of icons can be displayed in the launcher region 70 at a time.

Here, in the launcher region 70 shown in FIG. 6B, there is a width 340 at only the right side of the line of icons such as the icon 210. Meanwhile, in the launcher region 70 shown in FIG. 6A, widths 350 and 352 are provided at both ends of the line of icons such as the icon 210. Therefore, user can clearly recognize that there is the icon 218 which is not displayed in the launcher region 70 shown in FIG. 6A.

Here, icons stored in the icon storage section 170 may be icons having deferent icon widths each other.

In the case that one icon width stored in the icon storage section 170 is smaller than the width obtained by adding the arrow width 300 and the arrow width 302 shown in FIG. 6A, the one icon can be displayed in the launcher region 70 provided that the arrow icons 200 and the arrow icon 202 are not arranged in the launcher region 70, the arrangement section 130 may arrange the icon image of tie one icon as substitute for the arrow icon 200 and the arrow icon 202.

The arrangement section 130 may arrange the icons from the right side of the launcher region 70. Additionally, the launcher region 70 may be vertically long, and the arrangement section 130 may arrange vertically the plurality of icons to display. In this case, the arrangement section 130 may arrange the icons from the upper side of the launcher region 70 for example.

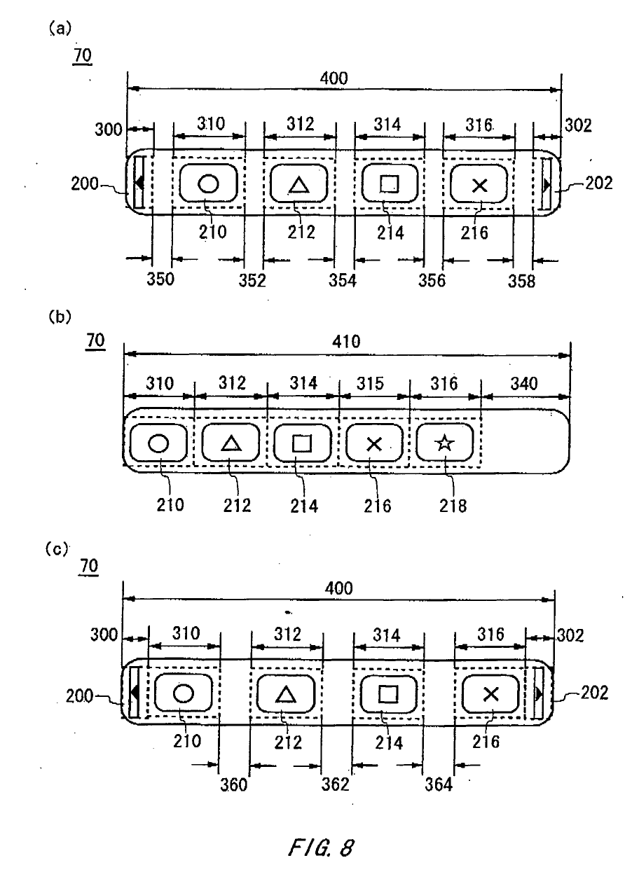

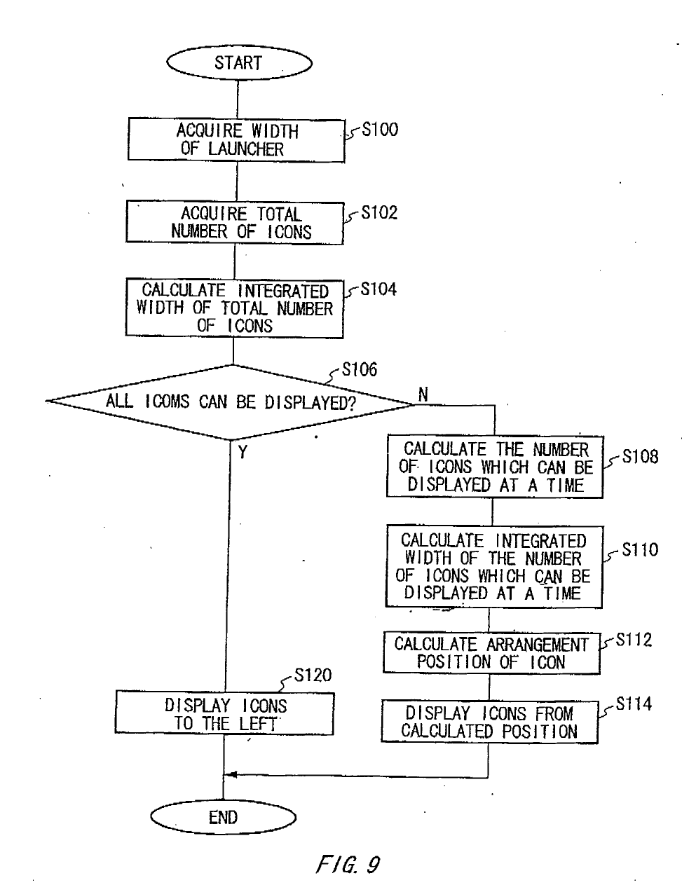

FIG. 8 shows an example of icons displayed in the launcher region 70. FIG. 9 is a flowchart showing an example of operation of the icon display apparatus 10. The flowchart starts by receiving an instruction from a user that the width of the window 60 shown in FIG. 3 will be changed. Here, at the starting point of the flowchart, the icon storage section 170 stores icons 210, 212, 214, 216 and 218. The width for each of the icons 210, 212, 214, 216 and 218.is icon width 310, 312, 314, 316 and 318, respectively. The order to arrange the icons 210, 212, 214, 216 and 218 is as the described order.

The launcher width acquiring section 100 acquires a launcher width 400 shown in FIG. 8A from the window width acquiring section 160 (S100). The launcher width acquiring section 100 provides the acquired launcher width 400 to the number of icons calculating section 110 and the arrangement section 130.

The total number acquiring section 140 acquires the total number of icons “5” stored in the icon storage section 170 (S102). The total number acquiring section 140 calculates an integrated width for the total number “5” of icons stored in the icon storage section 170, that is, the integrated width of the icon widths 310, 312, 314, 316 and 318 (S104). The total number acquiring section 140 provides the integrated width for the calculated total number “5” of icons to the number of icons calculating section 110.

The number of icons calculating section 110 determines whether the five icons can be displayed in the launcher region 70 by comparing the launcher width 400 with the calculated integrated width (S106).

Determining that the five icons can not be displayed in the launcher region 70 (S106: No), the number of icons calculating section 110 calculates the number of icons which can be displayed at a time (S108). Specifically, the number of icons calculating section 110 firstly reads the icon width, the arrow width of the arrow icon and the arrangement order information, and then calculates the number of icons which can be displayed at a time based on the read icon width and the launcher width acquired from the launcher width acquiring section 100 (S108).

In an example shown in FIG. 8A, the number of icons calculating section 110 firstly calculates an icon arrangement possibility width obtained by subtracting an arrow width 300 of the arrow icon 200 and an arrow width 302 of the arrow icon 202 from the acquired launcher width 400. The number of icons calculating section 110 determines whether the icon width of the first icon 210 is smaller than the icon arrangement possibility width. As shown in FIG. 8A, determining that the icon width 310 is smaller the icon arrangement possibility width, the number of icons calculating section 110 calculates a value obtained by subtracting the icon width 310 from the icon arrangement possibility width as a new icon arrangement possibility width. Next, the number of icons calculating section 110 also determines whether an icon width 312 of the second icon 212 is smaller than the icon arrangement possibility width. As shown in FIG. 8A, determining tat the icon width 312 is smaller than the icon arrangement possibility width, the number of icons calculating section 110 calculates a value obtained by subtracting the icon width 312 from the icon arrangement possibility width as a new icon arrangement possibility width. In the same way, the number of icons calculating section 110 determines whether the icon width of a fifth icon 218 is smaller than the icon arrangement possibility width. As shown in FIG. 8A, determining that the icon width 318 is larger than the icon arrangement possibility width, the number of icons calculating section 110 acquires icon IDs to identify the icons from the first to the fourth, 210, 212, 214 and 216. The number of icons calculating section 110 calculates the acquired number “4” of icon IDs as the number of icons “4” which can be displayed at a time (S108). The number of icons calculating section 110 provides the calculated number of icons to the integrated width calculating section 120 and the arrangement section 130.

The integrated width calculating section 120 calculates an integrated width for which the number “4” of icons which can be displayed at a time are arranged laterally, that is, the integrated width of the icon widths 310, 312, 314 and 316 based on the number of icons acquired from the number of icons calculating section 110, the arrangement order information stored in the icon storage section 170 and the icon width (S110). The integrated value calculating section 120 provides the calculated integrated value to the arrangement section 130.

The arrangement section 130 calculates the position of each of the icons 210, 212, 214 and 216 in the arrangement (S112). Specifically, the arrangement section 130 firstly reads the arrow widths 300 and 302 from the icon storage section 170, and calculates an adding width obtained by adding the read arrow widths 300 and 302 and the integrated width of the icon widths 310, 312, 314 and 316 acquired from the integrated width calculating section 120. The arrangement section 130 subtracts the calculated adding width from the launcher width 400 acquired from the launcher width acquiring section 100 and divides the subtracted width by the number “5” obtained by adding 1 to the number of icons “4” notified from the number of icons calculating section 100 to calculate distance widths 350, 352, 354, 356 and 358.

Next, the arrangement section 130 calculates a position obtained by adding the arrow width 300 of the arrow icon 200 and the distance width 350 to the left edge of the launcher region 70 as the position at which the icon 210 is arranged as shown in FIG. 8A. In the same way, the arrangement section 130 calculates a position obtained by adding the icon width 310 of the icon 210 and the distance width 352 to the position of the icon 210 as the position at which the icon 212 is arranged. Additionally, the arrangement section 130 calculates a position obtained by adding the icon width 312 of the icon 212 and the distance width 354 to the position of the icon 212 as the position at which the icon 214 is arranged. Further, the arrangement section 130 calculates a position obtained by adding the icon width 314 of the icon 214 and the distance width 356 to the position of the icon 214 as the position at which the icon 216 is arranged (S110).

The arrangement section 130 determines the left edge of the launcher region 70 as the position at which the arrow icon 200 is arranged. Additionally, the arrangement section 130 calculates a position obtained by subtracting the arrow width 302 of the arrow icon 202 from the right end of the launcher region 70 as the position at which the arrow icon 202 is abed (S110).

As shown in FIG. 8A, the arrangement section 130 arranges the icon image for each of the icons 210, 212, 214 and 216, and the arrow icons 200 and 202 in the launcher region 70 such that the left edge of each image is at each calculated position (S114). Thereby the arrangement section 130 symmetrically and evenly arranges the icons 210, 212, 214 and 216 in the launcher region 70.

Meanwhile, ken the number of icons calculating section 110 determines that the total number “5” of icons can be displayed in the launcher region 70 (S106: Yes), the arrangement section 130 arranges, beginning from the left edge of the launcher region 70, the total number “5” of icons with narrowing the distances each between the total number “5” of icons, acquired from the total number acquiring section 140, that is, the line of icons 210, 212, 214, 216 and 218 (S120). Specifically, as shown in FIG. 8B, the arrangement section 130 firstly arranges the icon image of the icon 210 such that the left edge of the icon image of the icon 210 is at the left edge of the launcher region 70 (S120). Next, the arrangement section 130 arranges the icon image of the icon 210 such that the left edge of the icon image of the icon 212 is at a position obtained by adding the icon width 310 of the icon 210 to the left edge of the launcher region 70. In the same way, the arrangement section 130 sequentially arranges the icon image for each of the icons 214, 216 and 218 (S120).

For example, when the number of icons calculating section 110 acquires a launcher width 410 wider than the launcher width 400 from the launcher width acquiring section 100 because the window is enlarged by the user, the arrangement section 130 arranges the total number of icons in the launcher region 70 to the left edge. Here, when the total number of icons can be arranged to display at a time in the launcher region 70, any arrow icon is not displayed.

Here, in the launcher region 70 shown in FIG. 8B, there is an width 340 at only the right side of the line of icons such as the icon 210. Meanwhile, in the launcher region 70 shown in FIG. 8A, distance widths 350, 352, 354, 356 and 358 are evenly provided. Therefore, even if there is a space at the right side of the launcher region 70 shown in FIG. 8A, user's misunderstanding that all of the icons are displayed in the launcher can not be caused. In other words, the user can clearly recognize that there is the icon 218 in the launcher region 70 shown in FIG. 8A.

Additionally, in the launcher region 70 shown in FIG. 8B, the icons 210, 212, 214, 216 and 218 are asymmetrically arranged to the left. Meanwhile, in the launcher region 70 shown in FIG. 8A, the icons 210, 212, 214, 216 and 218 are symmetrically arranged. Therefore, the above-described user's misunderstanding can not be caused. Further, in the launcher region 70 shown in FIG. 8A, the arrow icons 200 and 202 are arranged, so that also the above-described user's misunderstanding can not be caused.

Here, the arrangement section 130 may arrange the icons 210, 212, 214 and 216 as shown in FIG. 8C instead of arranging those as shown in FIG. 8A. In this case, the arrangement section 130 subtracts an adding width obtained by adding the arrow widths 300 and 302, and the icon widths 310, 312, 314 and 316 from the launcher width 400 acquired from the launcher width acquiring section 100 and divides the subtracted width by the number of icons “3” obtained by subtracting 1 from the number of icons “4” notified from the number of icons calculating section 101 to calculate the distance widths 360, 362 and 364 (S112).

Next as shown in FIG. 8C, the arrangement section 130 calculates a position obtained by adding the arrow width 300 of the arrow icon 200 to the left edge of the launcher region 70 as the position at which the icon 210 should be arranged. In the same way, the arrangement section 130 calculates a position obtained by adding the icon width 310 of the icon 210 and the distance width 360 to the position of the icon 210 as the position at which the icon 212 should be arranged. Additionally, the arrangement section 130 calculates a position obtained by adding the icon width 312 of the icon 212 and the distance width 362 to the position of the icon 212 as the position at which the icon 214 should be arranged. Further, the arrangement section 130 calculates a position obtained by adding the icon width 314 of the icon 214 and the distance width 364 to the position of the icon 214 as the position at which the icon 216 should be arranged (S112).

Here, the icons stored in the icon storage section 170 may be icons having different widths each other.

In the case that one icon width stored in the icon storage section 170 is smaller than an width obtained by adding an arrow width 300 and an arrow width shown in FIG. 8A, the arrangement section 130 may arrange the icon image of the one icon as substitute for the arrow icon 200 and the arrow icon 202 if the one icon can be displayed in the launcher region 70 provided that the arrow icon 200 and the arrow icon 202 are not arranged in the launcher region 70.

The arrangement section 130 may arrange icons from the right side of the launcher 70. Additionally, the launcher region 70 may be vertically long, and the arrangement section 130 may arrange vertically the plurality of icons to display. In this case, the arrangement section 130 may range the icons from the upper side of the launcher region 70 for example.

Hereinbefore, the icon display method described with reference to FIG. 6-FIG. 9 is an example of icon display method that arranges the plurality of icons in the launcher such that the distance between one end of the launcher region and the icon arranged most close to the one end is approximately equal to the distance between the other end of launcher region and the icon arranged most close to the other end.

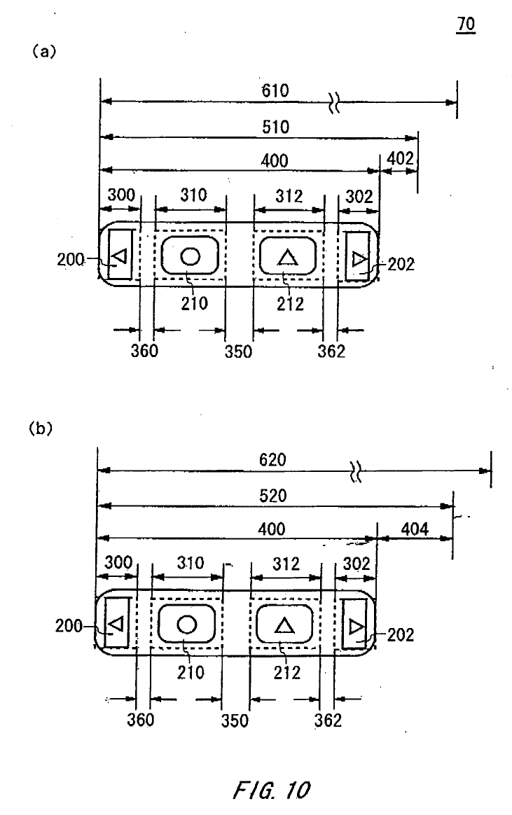

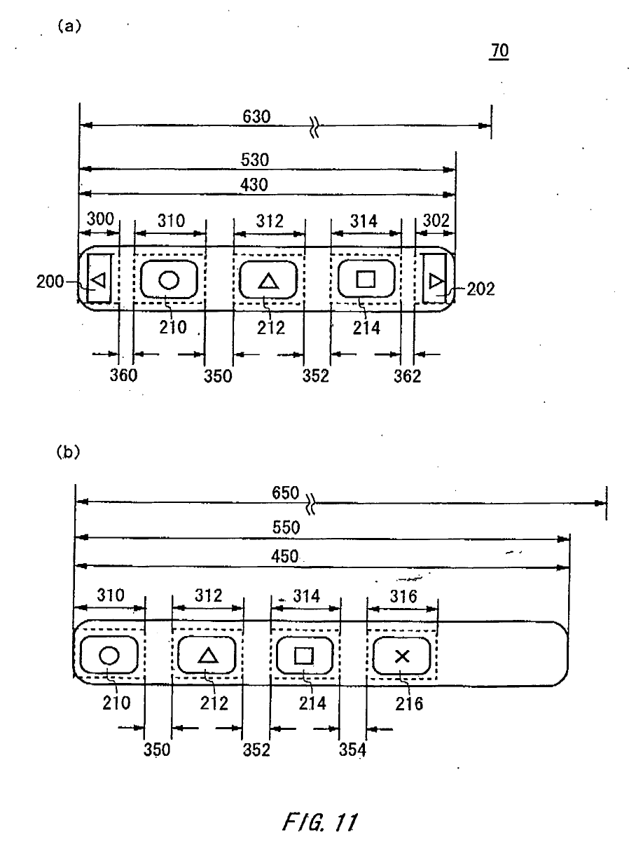

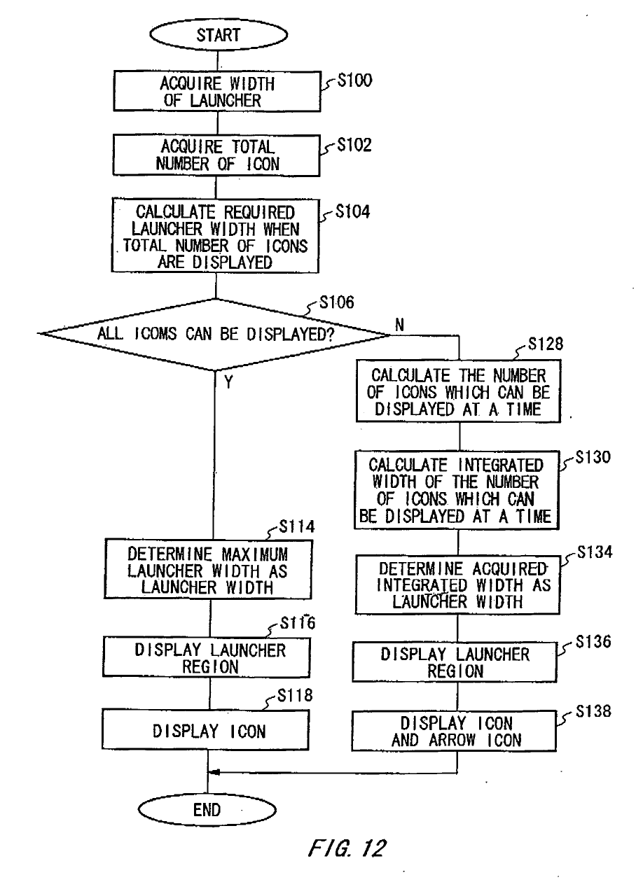

FIG. 10 and FIG. 11 show examples of icons such as an icon 210 in the launcher 70. FIG. 12 is a flowchart of an example of operation of the icon display apparatus 10. The flowchart starts by receiving au instruction from a user that the width of the window 60 shown in FIG. 5 will be changed. Here, at the starting point of the flowchart, the icon storage section 170 stores icons 210, 212, 214, and 216, and arrow icons 200 and 202. The width for each of the icons 210, 212, 214 and 216 is icon width 310, 312, 314 and 316, and the width for each of the arrow icons is arrow icon width 300 and 302, respectively. The order to arrange the icons 210, 212, 214 and 216 is as the described order. The icon storage section stores a predetermined distance width.

The window width acquiring section 160 notifies the launcher width acquiring section 100 of the received window width of the window 60. The launcher width acquiring section 100 calculates the maximum launcher width 510 shown in FIG. 10A based on the notified window width 610 (S100). The launcher width acquiring section 100 provides the calculated Rum launcher width 510 to the number of icons calculating section 110 and the launcher region displaying section 150.

The total number acquiring section 140 acquires the total number “4” of icons stored in the icon storage section 170 with reference to the icon storage section 170 (S102). Additionally, the total number acquiring section 140 calculates a required launcher width obtained by adding the icon width 310, 312, 314 and 316, a distance width 350 between the icon 210 and the icon 212, a distance width 352 between the icon 212 and the icon 214, and a distance width 354 between the icon 214 and the icon 216 (S104). The total number acquiring section 140 provides the calculated total number “4” and the required launcher width to the number of icons calculating section 110.

The number of icons calculating section 110 determines whether the four icons can be displayed within the launcher region 70 with the maximum launcher width 510 by comparing the maximum launcher width 510 with the required launcher width which has been acquired (S106) specifically, the number of icons calculating section 110 determines that the four icons can be displayed within the launcher region 70 when the required launcher width is less than the maximum launcher width 510 (S106). The number of icons calculating section 110 notifies of the determination the arrangement section 130 and the launcher region displaying section 150. Here, in the case of an example shown in FIG. 10A, the number of icons calculating section 110 determines that the four icons can not be displayed within the launcher region 70.

Determining that the four icons can not be displayed within the launcher region 70 (S106: No), the number of icons calculating section 110 calculates the number of icons which can be displayed at a time (S128). Specifically, the number of icons calculating section 110 firstly calculates an adding width obtained by adding the arrow width 300, the distance width 360, the icon width 310, the distance width 362 and the arrow width 302 with reference to the icon storage section 170. Then, the number of icons calculating section 110 determines whether the calculated adding width is less than the acquired maximum launcher width 510. Determining that the adding width is not less than the maximum launcher width 510, the number of icons calculating section 110 calculates the number of icon “0” which can be displayed at a time because a region in which the first icon 210 should be arranged can not be secured.

Meanwhile, determining that the adding width is less than the maximum launcher width 510, the number of icons calculating section 110 calculates a new adding width by adding the distance width 350 and the icon width 312 to the adding width. The number of icons calculating section 110 determines whether the adding width which is newly calculated is less than the maximum launcher width 510. Hereinafter in the same way, the number of icons calculating section 110 calculates an adding width by incrementing the number of icons one by one and calculates the number of icons for which the adding width is more than the maximum launcher width 510. In an example shown in FIG. 10A, the number of icons calculating section acquires the number of icons “2” which can be displayed at a tie (S106). The number of icons calculating section 110 notifies of the calculated number of icon “2” the integrated width calculating section 120 and the arrangement section 130.

The integrated width calculating section 120 calculates an integrated width obtained by adding the arrow widths 300 and 302, the icon widths 310 and 312, and the distance widths 360, 352 and 362 as the integrated width for the number of icons “2” which can be displayed at a time based on the number of icons “2” acquired from the number of icons calculating section 110, the arrangement order stored in the icon storage section 170 and the icon width (S130). The integrated width calculating section 120 provides the calculated integrated width to the launcher region displaying section 150.

The launcher region displaying section 150 determines the integrated width acquired from the integrated width calculating section 120 as a launcher width 400 (S134). The launcher region displaying section 150 displays the launcher region 70 with the determined launcher width 400 as shown in FIG. 10A (S136).

As shown in FIG. 10A, the arrangement section 130 arranges the icons 210 and 212, and the arrow icons 200 and 202 to display based on the number of icons “2” notified by the number of icons calculating section 110, he arrangement order information stored in the icon storage section 170 and the icon width (S138). Then, the flowchart is ended. Thereby the arrow icon is arranged adjacent to the icon 212, so that even if the distance between the icon 212 and the arrow icon 202 is widened, user's misunderstanding that all of the icons are displayed in the launcher can not be caused. Additionally, the edge of the launcher region 70 is displayed adjacent to the arrow icon 202, so that the other region 80 can be widened in comparison with the case that the launcher width 400 is the maximum launcher width 510.

Now, it will be described about an operation when the window width acquiring section 160 receives again an instruction from the user that an window width 610 shown in FIG. 10A is widened. Here, the operation same as the above-described operation will not be repeatedly described.

In a step S100, the launcher width acquiring section 100 calculates the maximum launcher width 520 shown in FIG. 10B based on an window width 620 larger than the window width 610 notified by the window width acquiring section 160 (S100).

In a step S106, the number of icons calculating section 110 determines that the four icons can not be displayed within the launcher region 70 with the maximum launcher width 520 by comparing the maximum launcher width 520 with the required launcher width which has been acquired (S106: No).

In a step S128, the number of icons calculating section 110 calculates the number of icons “2” which can be displayed at a time (S128). That is to say, since an width 404 shown in FIG. 10B is wider than an width 402 shown in FIG. 10A but the width 404 is still smaller than an width obtained by adding the distance width 352 and the icon width 314, the number of icons calculating section 110 calculates the number of icons “2” which can be displayed at a time. Hereinafter, through a step S130, a step S134, a step S136 and a step S138, the launcher region 70 and icons such as the icon 210 are displayed same as the FIG. 10A.

Additionally, it will be described about an operation when the window width acquiring section 160 receives an instruction from the user that an window width 620 shown in FIG. 10B is widened. Here, the operation same as the above-described operation will not be repeatedly described.

In a step S100, the launcher width acquiring section 100 calculates the maximum launcher width 530 shown in FIG. 10A based on an window width 630 larger than the window width 620 notified by the window width acquiring section 160 (S100).

In a step S106, the number of icons calculating section 110 determines that the four icons can not be displayed within the launcher region 70 with the maximum launcher width 530 by comparing the maximum launcher width 530 with the required launcher width which has been acquired (S106: No).

In a step S128, the number of icons calculating section 110 calculates the number of icons “3” which can be displayed at a time (S128). That is to say, the number of icons calculating section 110 calculates the number of icons “3” which can be displayed at a time (S128) because the maximum launcher width, 530 is widened up to the adding width obtained by adding the arrow widths 300 and 302, the icon widths 310, 312 and 314, and the distance widths 360, 362, 350 and 352 as shown in FIG. 11A. Hereinafter, trough a step 5130, a step S134, a step S136 and a step S138, the launcher region 70 and the icons such as the icon 210 are displayed as shown in FIG. 11A.

Additionally, it will be described about an operation when the window width acquiring section 160 receives an instruction from the user that the window width 630 shown in FIG. 11A is widened. Here, the operation same as the above-described operation will not be repeatedly described.

In a step S100, the launcher width acquiring section 100 calculates the maximum launcher width 550 shown in FIG. 11B based on an window width 650 larger an the window width 630 notified by the window width acquiring section 160 (S100).

In a step S106, the number of icons calculating section 110 determines that the four icons can be displayed within the launcher region 70 with the maximum launcher width 550 by comparing the maximum launcher width 550 with the required launcher width which has been acquired (S106: Yes). Additionally, the number of icons calculating section 110 notifies the arrangement section 130 of the number of icons “4” acquired by the total number acquiring section 140.

The launcher region displaying section 150 determines the maximum launcher width 550 acquired from the launcher width acquiring section 110 as the launcher width 450 (S114). The launcher region displaying section 150 displays the launcher region 70 with the determined launcher width 450 as shown in FIG. 11B (S116).

The arrangement section 130 arranges the icons 210, 212, 214 and 216 as shown in FIG. 11B to display with reference to the total number of icons “4” notified by the number of icons calculating section 110, and the icon width, the arrangement order information and the distance width stored in the icon storage section 170 (S138). Thereby when the total number of icons can not be arranged in the launcher region 70 to display at a time, the arrow icon is displayed adjacent to the other icon as shown in FIG. 10 and FIG. 11A. Meanwhile, he total number of icons can be arranged in the launcher region 70 to display at a time, the icons are displayed as shown in FIG. 11B. Therefore, when the total number of icons can not be arranged in the launcher region to display at a time, the user can clearly recognize that there is any icon which is not displayed in the launcher region based on the difference between those displays.

Additionally, according to the present embodiment, even if the window width is widened, the width of the launcher region 70 is not widened until the width is widened to be capable of displaying a new icon. Then, when the window width is widened to be capable of displaying the new icon, the launcher region is widened and a new icon is added in the launcher region 70 to display the same. Therefore, even if the window width is widened by less than one icon width so that the distance between the icon, particularly the icon which is arranged at the right most and the right edge of the launcher region 70 are widened, the user's misunderstanding that all of the icons are displayed in the launcher can not be caused.

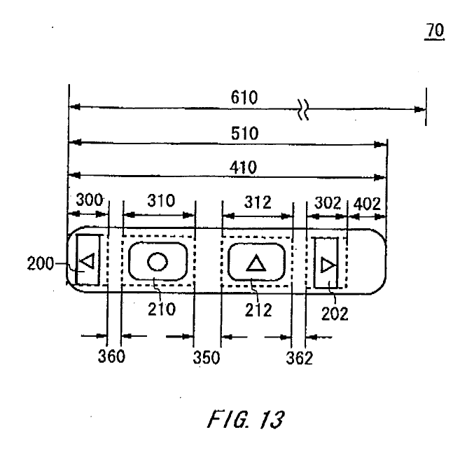

FIG. 13 shows an example of icons such as the icon 210 in the launcher region 70. In a step S134, the launcher region displaying section 150 may determine that the maximum launcher width acquired from the launcher width acquiring section 100 as the launcher width instead of determining that the integrated width acquired from the integrated width calculating section 120 as the launcher width. When the launcher width acquiring section 150 determines he maximum launcher width acquired from the launcher width acquiring section 100 as the launcher width, the launcher region 70 with the launcher width 400 shown in FIG. 10A is displayed with the launcher width 410 equal to the maximum launcher width 510 as shown in FIG. 13. Thereby the arrow icon 202 is arranged adjacent to the icon 212. Therefore, even if the distance between the icon 212 and the arrow icon 202 is widened, the user's misunderstanding that all of the icons are displayed in the launcher can not be caused. That is to say, the arrow icon 202 and the icon 212 are arranged adjacently with the distance width 362 as shown in FIG. 13, so that the user's misunderstanding that all of the icons are displayed in the launcher cam not be caused differently from the case that the icon 202 and the icon 212 are arranged with the width obtained by adding the distance width 362 and the width 402.

Here, when the arrangement section 130 arranges an arrow icon, the arrow icon have to be ranged at the position closer to the position at which the next icon will be ranged as shown in FIGS. 10A and 11A. Specifically, the arrangement section 130 arranges the arrow icon 202 with the distance width 362 smaller than the distance width 350. Thereby even if the distance between the icon arranged at the edge of the launcher region 70 and the arrow icon is widened, the user's misunderstanding that all of the icons are displayed in the launcher can not be certainly caused.

Additionally, when the arrangement section 130 arranges an arrow icon, the arrow icon may be arranged at a position at which the next icon will be arranged instead of the position closer to the position at which the next icon will be arranged. Specifically, the arrangement section 130 may arrange the arrow icon 202 with the distance width 362 the same as the distance width 350. Thereby even if the distance between the icon arranged at the edge of the launcher region 70 and the arrow icon is widened, the user's misunderstanding tat all of the icons are displayed in the launcher also can not be more certainly caused.

According to the present embodiment as described above, the arrow icon is arranged adjacent to the icon, so that even if the distance between the icon arranged at the end of the line of icons in the launcher region is widened, the user's misunderstanding that all of the icons are displayed in the launcher also can not be caused.

Here, the arrangement section 130 does not necessarily use a part of or all of the distance widths 350, 352, 354 and 356 when the icons and arrow icons are arranged.

According to the present embodiment as described above, the user can more certainly recognize whether there is any icon which is not displayed in the launcher region 70.

While the present invention have been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. An icon displaying method comprising:
acquiring a launcher width in the icon arranging direction in the launcher region in which a plurality of icons are arranged to display;
calculating the number of icons arranged in the launcher to display at a time based on the launcher width acquired in the launcher width acquiring step and the icon width for each of the plurality of icons;
calculating an integrated width in the icon arranging direction in which the number of icons calculated in the number of icons calculating step are arranged; and
arranging the plurality of icons in the launcher such that the distance between one end of the launcher region and the icon arranged most close to the one end is approximately equal to the distance between the other end of launcher region and the icon arranged most close to the other end.

2. The icon displaying method according to claim 1, wherein the arranging arranges the line of icons at the center of launcher based on the integrated width and the launcher width.

3. The icon displaying method according to claim 2,wherein the arranging step arranges, beginning from the edge of the launcher, the line of icons at the center of the launcher by arranging the first icon of the number of icons from the position obtained by subtracting the integrated width from the launcher width and dividing the subtracted width in half.

4. The icon displaying method according to claim 3 further comprising total number acquiring that acquires the total number of plurality of icons, wherein
the calculating step determines whether the total number of icons acquired by the total number acquiring can be arranged in the launcher to display at a time based on the launcher width and the icon width,
the arranging arranges the line of icons with the number of icons at the center of the launcher when the total number of icons can not be arranged in the launcher to display at a time, and
the arranging arranges the line of the total number of icons to one side of the launcher by arranging the first icon to one end of the total number of icons when the total number of icons can be arranged in the launcher to display at a time.

5. The icon displaying method according to claim 4 displays arrow icons at both ends of the line of icons.

6. The icon displaying method according to claim 1, wherein the arranging symmetrically and evenly arranges the number of icons in the launcher based on the integrated width and the launcher width.

7. The icon displaying method according to claim 6 further comprising total number acquiring that acquires the total number of plurality of icons, wherein
the calculating determines whether the total number of icons acquired by the total number acquiring can be arranged in the launcher to display at a time based on the launcher width and the icon width,
the arranging symmetrically and evenly arranges the number of icons in the arranging direction when the total number of icons can not arranged in the launcher to display at a time, and
the arranging arranges the line of the total number of icons to one side by arranging the line of the total number of icons with narrowing the distances each between icons from the edge of the launcher.

8. The icon displaying method according to claim 7, wherein the arranging displays arrow icons at both ends of the line of the number of icons when the total number of icons can not be arranged in the launcher to display at a time.

9. The icon displaying method according to claim 8, wherein the arranging subtracts the integrated width and the arrow icon width in the icon arranging direction from the launcher width and divides the subtracted width by a number obtained by adding 1 to the number of icons to calculate a distance width, and arranges the number of icons with the distance width in the launcher when the total number of icons can not be displayed in the launcher to display at a tire.

10. Am icon displaying method comprising:
acquiring a launcher width in the icon arranging direction in the launcher region in which a plurality of icons are arranged to display;
calculating the number of icons arranged in the launcher to display at a time based on the launcher width acquired in the launcher width acquiring step and the icon width for each of the plurality of icons; and
arranging the number of icons from one end of the line of icons in the launcher based on the launcher width acquired in the launcher width acquiring step and the icon width for each of the plurality of icons and arranging an arrow icon adjacent to the icons at least at the other end of line of icons in the launcher.

11. The icon displaying method according to claim 10 further comprising:
calculating an integrated width in the icon arranging direction in which the number of icons calculated in the calculating are arranged; and
displaying the edge of the launcher region adjacent to the arrow icon based on the integrated width.

12. The icon displaying method according to claim 10, wherein the arranging displays the arrow icon at the position at which an icon next to the number of icons should be arranged, or the position closer to the former.

13. The icon displaying method according to claim 10 further comprising total number acquiring that acquires the total number of plurality of icons, wherein the calculating determines whether the total number of icons acquired in the total number acquiring can be arranged in the launcher to display at a time based on the launcher width and the icon width,
the arranging arranges the number of icons from the one end of the line of icons in the launcher and arranges an arrow icon adjacent to the icons at least one end of the line of icons in the launcher, and
the arranging arranges the number of icons from the one end of the line of icons in the launcher when the total number of icons can be arranged in the launcher to display at a time.

14. An icon displaying method comprising:
acquiring a launcher width in the icon arranging direction in the launcher region in which a plurality of icons are arranged to display;
acquiring the total number of plurality of icons;
calculating the number of icons arranged in the launcher to display at a time based on the launcher width acquired in the launcher width acquiring step and the icon width for each of the plurality of icons;
determining whether the total number of icons acquired in the total number acquiring can be arranged in the launcher to display at a time; and
arranging the number of icons calculated by the calculating such that the relative positional relationship among one end of the launcher region, the first icon of the plurality of icons in the arrangement order and the second icon of the plurality of icons in the arrangement order is a predetermined first positional relationship in a first state that the total number of icons can not be arranged in the launcher to display at a time, and that arranges the total number of icons such that the relative positional relationship among one end of the launcher region, the first icon of the plurality of icons in the arrangement order and the second icon of the plurality of icons in the arrangement order is a predetermined second positional relationship different from the first positional relationship in a second state that the total number of icons can be arranged in the launcher to display at a time.

15. An icon display apparatus comprising:
a launcher width acquiring section that acquires a launcher width in the icon arranging direction in the launcher region in which a plurality of icons are arranged to display;
the number of icons calculating section that calculates the number of icons arranged in the launcher to display at a time based on the launcher width acquired by the launcher width acquiring section and the icon width for each of the plurality of icons;
an integrated width calculating section that calculates an integrated width in the icon arranging direction in which the number of icons calculated by the number of icons calculating section are arranged; and
an arrangement section that arranges the line of icons at the center of launcher based on the integrated width and the launcher width.
